(19) United States
(12) Patent Application Publication
(10) Pub. No.: US 2026/0197882 A1
(43) Pub. Date: Jul. 9, 2026

(54) VEHICLE CONTROL APPARATUS AND METHOD THEREOF

(71) Applicants: Hyundai Motor Company, Seoul (KR); Kia Corporation, Seoul (KR)

(72) Inventors: Seong Soo YAE, Hwaseong-Si (KR); Hyun Woo LEE, Hwaseong-Si (KR); Seo Hwan CHOI, Hwaseong-Si (KR)

(21) Appl. No.: 19/324,881

(22) Filed: Sep. 10, 2025

(30) Foreign Application Priority Data
Jan. 8, 2025 (KR) 10-2025-0003118

(51) Int. Cl. H04W 76/11; H04W 4/40

(52) U.S. Cl. CPC H04W 76/11; H04W 4/40

(57) ABSTRACT

An apparatus of a vehicle may comprise a processor and a memory storing at least one instruction that, when executed by the processor communicating with the memory, is configured to cause the apparatus to store a first user profile and a first link key associated with a wireless device, obtain a second user profile registration request in a state in which a physical address of the wireless device and the first link key are stored in association with the first user profile, activate a pairing mode based on the second user profile registration request, obtain a registration request message from the wireless device, generate a second link key based on the physical address, update the first link key, and transmit the second link key.

### CROSS-REFERENCE TO RELATED APPLICATION

This application claims the benefit of priority to Korean Patent Application No. 10-2025-0003118, filed in the Korean Intellectual Property Office on Jan. 8, 2025, the entire contents of which are incorporated herein by reference.

### TECHNICAL FIELD

The present disclosure relates to a vehicle control apparatus for wireless communication and a method thereof, and more particularly, relates to pairing between a vehicle control apparatus for a wireless device link and a nearby device.

### BACKGROUND

The matters described in this Background section are only for enhancement of understanding of the background of the disclosure, and should not be taken as acknowledgment that they correspond to prior art already known to those skilled in the art.

A vehicle has been developed in a manner which provides a function which is combined with various convenience devices to provide user convenience, other than a function as transportation. Representatively, the vehicle may include a device for providing infotainment. The infotainment is a combination of information and entertainment, which refers to a device for providing information, audio, and visual entertainment. With the development of telematics, connected car, and autonomous vehicle technology, an in-vehicle infotainment (IVI) has greatly increased a role and importance in notifying a user of information of the vehicle or directly controlling the vehicle beyond a simple multimedia device.

The vehicle may interwork with a nearby device, such as a personal portable terminal owned by the user, to perform more various functions. The vehicle and the nearby device may be connected based on wired communication, such as a universal serial bus (USB) cable, but a short range wireless communication connection scheme is mainly preferred. The vehicle may interlock and operate a user profile with a nearby device of a specific user.

A plurality of user profiles may be registered in the vehicle. As related information interworks with the user profile for each nearby device, to change the nearby device from a previously registered profile to another profile, the user should perform all processes again after deleting the user profile. Improving usability for user convenience, in a change between profiles or additional registration, is considered.

### SUMMARY

The present disclosure has been made to solve the above-mentioned problems.

According to the present disclosure, an apparatus of a vehicle, the apparatus may comprise, a processor, and a memory storing at least one instruction that, when executed by the processor communicating with the memory, is configured to cause the apparatus to, store a first user profile and a first link key associated with a wireless device, obtain a second user profile registration request, in a state in which a physical address of the wireless device and the first link key are stored in association with the first user profile in the memory, activate, based on the second user profile registration request, a pairing mode, obtain, from the wireless device, a registration request message, generate, based on the physical address of the wireless device, a second link key with a second value for a link with the wireless device, update, based on the second link key, the first link key in association with the first user profile, and transmit, via a wireless communication interface of the vehicle, the second link key to the wireless device.

The apparatus, wherein the at least one instruction, when executed by the processor communicating with the memory, is configured to cause the apparatus to, match the second link key with the second user profile to store the second link key in the memory.

The apparatus, wherein the first link key has a first value and the second link key has the second value, and, wherein the at least one instruction, when executed by the processor communicating with the memory, is configured to cause the apparatus to, after the second link key is generated, change the first value of the first link key to the second value.

The apparatus, wherein the at least one instruction, when executed by the processor communicating with the memory, is configured to cause the apparatus to, store the second link key and the physical address of the wireless device in association with the second user profile in the memory.

The apparatus, wherein the physical address may comprise a Bluetooth address of the wireless device.

The apparatus, wherein the registration request message may comprise the physical address of the wireless device.

The apparatus, wherein the at least one instruction, when executed by the processor communicating with the memory, is configured to cause the apparatus to, determine whether the physical address included in the registration request message is an address previously stored in the memory.

The apparatus, wherein the at least one instruction, when executed by the processor communicating with the memory, is configured to cause the apparatus to, retrieve, based on a determination that the physical address is the address previously stored in the memory, a link key associated with the physical address.

The apparatus, wherein the registration request message may comprise a pin code associated with the apparatus.

The apparatus, further may comprise, a display, wherein the at least one instruction, when executed by the processor communicating with the memory, is configured to cause the apparatus to, display a pin code on the display, while operating in the pairing mode.

The apparatus, wherein the at least one instruction, when executed by the processor communicating with the memory, is configured to cause the apparatus to, transmit a broadcasting message, while operating in the pairing mode.

The apparatus, wherein the broadcasting message may comprise a physical address of the vehicle.

The apparatus, wherein the physical address of the vehicle may comprise a media access control (MAC) address.

The apparatus, further may comprise, a display, wherein the at least one instruction, when executed by the processor communicating with the memory, is configured to cause the apparatus to, obtain, via the display, the second user profile registration request.

The apparatus, wherein the at least one instruction, when executed by the processor communicating with the memory, is configured to cause the apparatus to, transmit or receive, via the wireless communication interface, data with the wireless device using the first link key, while the wireless device is linked to the first user profile, and, transmit or receive, via the wireless communication interface, data to or from the wireless device using the second link key, while the wireless device is linked to the second user profile, and, wherein a value corresponding to the first link key for the wireless device is the same as a value corresponding to the second link key while the wireless device is linked to the second user profile.

According to the present disclosure, a method performed by an apparatus of a vehicle, the method may comprise, obtaining a second user profile registration request for registering a second user profile, in a state in which a physical address of a wireless device and a first link key are stored in association with a first user profile in a memory of the apparatus, activating, based on the second user profile registration request, a pairing mode, obtaining a registration request message from the wireless device, generating, based on the physical address of the wireless device, a second link key for a link with the wireless device, transmitting, via a wireless communication interface of the vehicle, the second link key to the wireless device, and updating, based on the second key link, the first link key in association with the first user profile.

The method may further comprise, matching the second link key with the second user profile to store the second link key in the memory of the apparatus.

According to the present disclosure, a vehicle may comprise, a wireless communication interface, a processor, and a memory storing at least one instruction that, when executed by the processor communicating with the memory, is configured to cause the vehicle to, store a plurality of user profiles, wherein each user profile may comprise a set of records associated with at least one wireless device, and each record of the set of records may comprise a physical address and a link key associated with the wireless device, receive, from the wireless device, a request to register the wireless device under a second user profile, wherein the physical address of the wireless device is previously registered under a first user profile with a first link key, and wherein the first link key is stored in association with the first user profile, perform, in response to the request, a pairing operation with the wireless device to generate a second link key associated with the physical address of the wireless device, store the second link key in association with the second user profile, for the record, of the first user profile, associated with the at least one wireless device, update the first link key with the second link key, transmit, via the wireless communication interface, a signal indicating that the second link key is associated with the second user profile, and control, based on the signal, wireless communication between the vehicle and the wireless device using the second link key.

The vehicle, wherein the at least one instruction, when executed by the processor communicating with the memory, is configured to cause the vehicle to store, for each user profile of the plurality of user profiles, up to a predetermined number of records associated with a plurality of wireless devices, each record may comprise a distinct physical address and a corresponding link key.

The vehicle, wherein the at least one instruction, when executed by the processor communicating with the memory, is configured to cause the vehicle to, after generating the second link key, identify user profiles that include a record associated with the same physical address of the wireless device, and replace each corresponding link key in the identified user profiles with the second link key.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a configuration of a vehicle system including a vehicle control apparatus for a wireless device link according to an example of the present disclosure;

FIG. 2 shows an example of a profile link between a nearby device and a vehicle control apparatus for a wireless device link according to an example of the present disclosure;

FIG. 3 shows an example of a method for registering a user profile in a vehicle control apparatus according to an example of the present disclosure;

FIG. 4 shows an example of a method for registering and pairing a user profile in a vehicle control apparatus for a wireless device link according to an example of the present disclosure;

FIG. 5 shows exemplary user profile management data according to an example of the present disclosure;

FIG. 6 shows exemplary user profile switching according to an example of the present disclosure;

FIG. 7 shows an example of a method for registering a user profile in a vehicle control system according to an example of the present disclosure;

FIG. 8 shows an example of a method for registering a user profile in a vehicle control system according to an example of the present disclosure;

FIG. 9 shows an example of a configuration of a vehicle control apparatus for a wireless device link according to an example of the present disclosure; and

FIG. 10 shows an exemplary computing system according to an example of the present disclosure.

### DETAILED DESCRIPTION

Hereinafter, some examples of the present disclosure will be described in detail with reference to the exemplary drawings. In adding the reference numerals to the components of each drawing, it should be noted that the identical component is designated by the identical numerals even when they are displayed on other drawings. Further, in describing the example of the present disclosure, a detailed description of well-known features or functions will be ruled out in order not to unnecessarily obscure the gist of the present disclosure.

In describing the components of the example of the present disclosure, terms such as first, second, “A”, “B”, (a), (b), and the like may be used. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

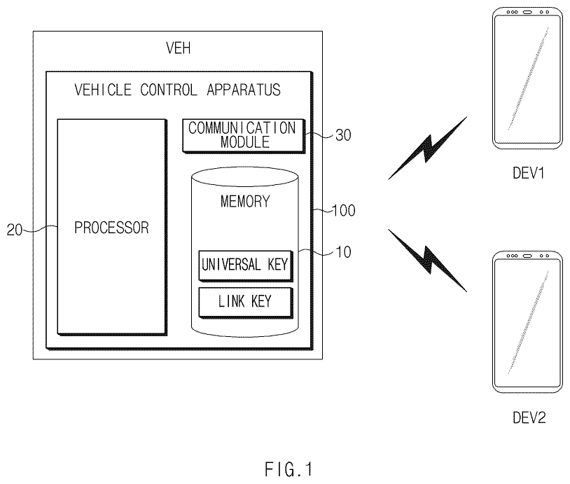

Hereinafter, examples of the present disclosure will be described in detail with reference to FIGS. 1 to 10.

FIG. 1 shows an example of a configuration of a vehicle system including a vehicle control apparatus for a wireless device link according to an example of the present disclosure.

Referring to FIG. 1, a vehicle control apparatus 100 for a wireless device link (hereinafter referred to as a vehicle control apparatus 100) according to an example of the present disclosure may be implemented in a vehicle VEH. In this case, the vehicle control apparatus 100 may be integrally configured with control units in the vehicle VEH or may be implemented as a separate device that is connected with the control units of the vehicle VEH by a separate connection means (e.g., wired harnesses, CAN bus interfaces, or Ethernet-based links, etc.).

The vehicle control apparatus 100 may be configured to link nearby devices DEV1 and DEV 2 located at places adjacent to the vehicle VEH to the vehicle VEH. The nearby devices DEV1 and DEV2 may be various devices, each of which includes an electronic control and communication circuit device capable of wirelessly communicating with the vehicle VEH (e.g., a smartphone, a smartwatch, a wireless headset, or a tablet, etc.). The vehicle control apparatus 100 may include a memory 10, a processor 20, and a communication module 30 (e.g., a wireless communication interface).

The memory 10 may include a universal key included in a broadcasting message broadcast to the nearby devices DEV1 and DEV2, a link key, and the like. The universal key may be information for distinguishing the vehicle VEH and may be registered in an operating system (OS) of each of the nearby devices DEV1 and DEV2 (e.g., Android OS, iOS, or other embedded systems, etc.).

The link key may include a link key for a link between a nearby device and a user profile. The link key may be stored by interworking with physical information of the nearby device. The physical information may include a Bluetooth address of the nearby device. The Bluetooth address may be, for example, a media access control (MAC) address. The physical information of the nearby device may also be stored in the memory 10 (e.g., as part of a device-pairing record or association table, etc.).

A predetermined number of account keys may be assigned to the link key for each user profile (e.g., user 1 or user 2, a family of users' profiles like husband/wife, etc.). For example, up to 6 account keys may be assigned according to a user profile operation policy (e.g., to support multiple phones, tablets, or other paired accessories per user, etc.).

The link key may be used for a communication link between the nearby device and the vehicle control apparatus 100. The nearby device and the vehicle control apparatus 100 may transmit and receive data using the link key. The link key may include, for example, an encrypted code (e.g., a 128-bit AES key, a session-based token, or a derived secure key, etc.). The nearby device and the vehicle control apparatus 100 may transmit or receive data encrypted by the link key.

The memory 10 may further include an account key. The account key may be information for distinguishing the nearby device with a history in which it is paired with an OS account. The account key may include account information of the nearby device (e.g., device user ID, application-level credentials, or cloud sync ID, etc.). Thus, the account key may be used to specify the nearby device which is a reception target, if broadcasting a broadcasting message including the account key.

A predetermined number of account keys may be assigned to the account key for each user profile (user 1 or user 2). For example, up to 6 account keys may be assigned according to the user profile operation policy. Each account key may include a nearby device account and an encrypted code. The encrypted code may be represented by any value (e.g., a binary string, hash output, or key digest, etc.).

The memory 10 may be provided in the processor 20 or may be configured independently of the processor 20. The memory 10 may be configured in a combination of a hard disk drive, a flash memory, an electrically erasable programmable read-only memory (EEPROM), a static random access memory (SRAM), a ferro-electric RAM (FRAM), a phase-change RAM (PRAM), a magnetic RAM (MRAM), a dynamic RAM (DRAM), a synchronous DRAM (SDRAM), a double date rate-SDRAM (DDR-SDRAM), or the like (e.g., depending on system architecture and durability requirements, etc.).

The processor 20 may generate a broadcasting message, based on a registration request associated with the user profile. The broadcasting message may be generated in response to a pairing mode operation command. The broadcasting message may include the universal key. The broadcasting message may be a message used to be registered in a new wireless device (e.g., DEV1) (e.g., a smartphone, a media player, a navigation tablet, or a smart key fob, etc.).

The processor 20 may perform communication with a specific nearby device corresponding to the link key using the link key generated in the pairing process. The processor 20 may establish a communication link with the specific nearby device and may perform data communication of the specific nearby device using the link key (e.g., for audio streaming, contact sync, or app-based services, etc.).

The communication module 30 (e.g., a wireless communication interface) may wirelessly communicate with the nearby devices DEV1 and DEV2 using any radio frequency (RF) or infrared (IR) technology, such as wireless-fidelity (Wi-Fi), Bluetooth brand communication, near field communication (NFC), radio frequency identification (RFID), and/or other wireless technologies (e.g., Ultra-Wideband (UWB), Zigbee, or proprietary protocols, etc.).

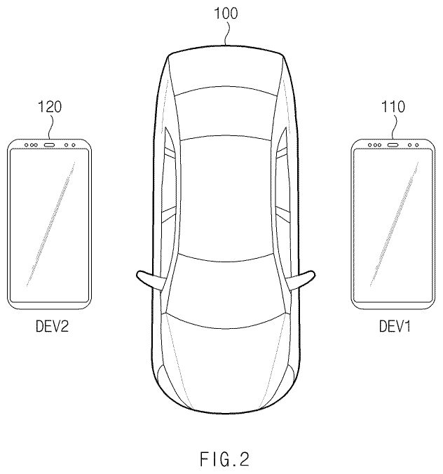

FIG. 2 shows an example of a profile link between a nearby device and a vehicle control apparatus for a wireless device link according to an example of the present disclosure.

A description will be given of a link relationship between a user profile stored in a vehicle control apparatus 100 and a nearby device (e.g., a wireless device) with reference to FIG. 2. In FIG. 2, it is assumed that a first user profile (USER 1) and a second user profile (USER 2) are stored as user profiles stored in the vehicle control apparatus 100. The user profile may be displayed on a display included in the vehicle control apparatus 100 or electrically or communicatively connected with the vehicle control apparatus 100. Passengers (or users) who ride in a vehicle may check a previously stored user profile via the display (e.g., on an infotainment touchscreen, a dashboard display, or a mobile-linked vehicle app, etc.).

Hereinafter, a description will be given assuming that a user of the first nearby device 110 (e.g., a wireless device) is stored by interworking or being matched with the first user profile (USER 1) and a user of the second nearby device 120 is stored by interworking or being matched with the second user profile (USER 2) (e.g., where the wireless devices are smartphones, smart key fobs, or media players, etc.).

In general, the vehicle control apparatus 100 may manage a nearby device for each user profile. If managing 6 wireless devices for each vehicle, the vehicle control apparatus 100 may register up to the 6 wireless devices for each of the first user profile (USER 1) and the second user profile (USER 2). The vehicle may manage a device for each user profile and may generate and manage a link key value for each wireless device in the user profile (e.g., to enable personalized settings such as preferred audio sources, contact sync, or navigation history, etc.).

Meanwhile, one Bluetooth module included in the vehicle control apparatus 100 may have one physical address (or a Bluetooth address or a BD address). A wireless device, such as a mobile phone, may recognize the vehicle as one external device by the physical address of the vehicle. Thus, an external device to which Bluetooth is applied may be one vehicle, from the point of view of wireless devices, and the wireless devices may store one link key transmitted from the external device. In other words, because the wireless device recognizes the vehicle as one device, it does not have specifications for generating or managing another link key (LinkKey) value like the vehicle (e.g., the phone assumes the vehicle is a single pairing target regardless of user identity, etc.).

Thus, if the user of the wireless device wants to be linked to another user profile rather than the previously stored user profile, he or she newly should proceed with a registration process between the wireless device and the vehicle. Furthermore, to register and pair a specific nearby device as a device of a profile different from an existing profile, the vehicle should remove a link key value previously registered for the wireless device and should generate a new link key value. The vehicle may store the previous link key value, If the link key changes to a new value, and the wireless device which communicates using the link key may fail to be linked to the vehicle. Although the vehicle attempts to communicate using the new key, the wireless device fail to recognize the new key as its own key. Thus, there is a problem in which the wireless device newly should perform a device registration or pairing process whenever changing the user profile. In other words, if the user of the specific wireless device attempts to switch between user profiles, there is inconvenience of having to repeat a registration process with the vehicle (e.g., re-entering pairing codes, re-authorizing access, or re-enabling media services, etc.).

Because the vehicle supports a multi-connection function, two or more wireless devices supporting Bluetooth may be used in a state in which they are linked to the vehicle at the same time. If there are two or more passengers, persons who sit in the passenger seats may link mutual devices to listen to or use music to listen to their own devices, rather than relying on a driver's account. In this case, there is a need for a function of easily switching a user profile, even if the user of the wireless device does not register and links a new device (e.g., to allow seamless switching between spouses or frequent drivers without re-pairing, etc.).

Hereinafter, the method for linking the user profile between the vehicle and the wireless device is proposed, if the user of the wireless device wants to be registered in a new user profile rather than an old user profile (e.g., due to a change in driver seat occupancy, driver recognition, or user preference settings, etc.).

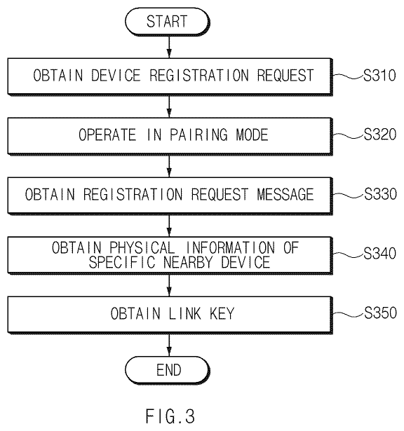

FIG. 3 shows an example of a method for registering a user profile in a vehicle control apparatus according to an example of the present disclosure.

Hereinafter, it is assumed that a vehicle control apparatus 100 of FIG. 1 performs a process of FIG. 3. Furthermore, in a description of FIG. 3, it may be understood that an operation described as being performed by a vehicle control apparatus is controlled by a processor 20 of the vehicle control apparatus 100 (e.g., for handling device registration, pairing workflows, or profile switching logic, etc.).

Referring to FIG. 3, a vehicle control apparatus (e.g., the vehicle control apparatus 100 of FIG. 1) may determine a link key value based on address information of a wireless device and may link a vehicle and the wireless device even without a separate new registration process (e.g., by using pre-existing authentication or synchronization data, etc.).

In S310, the vehicle control apparatus may obtain a device registration request for a specific user profile. The vehicle control apparatus may obtain a wireless device registration request for the specific user profile, depending on an input of a user (or a passenger) or an interaction with the user (e.g., pressing a pairing option, selecting a user name, or accepting a profile prompt on the infotainment screen, etc.). The vehicle control apparatus may obtain a registration request associated with the specific user profile, via its display.

In S320, the vehicle control apparatus may operate in a pairing mode. The vehicle control apparatus may operate in the pairing mode depending on the registration request. The vehicle control apparatus may broadcast a message including a physical address of the vehicle control apparatus. In this case, the transmitted message may be referred to as a broadcasting message (e.g., sent over Bluetooth advertising channels or a similar wireless protocol, etc.).

In S330, the vehicle control apparatus may obtain a registration request message from a specific wireless device. The specific nearby device may display information about the vehicle control apparatus on a display of the wireless device, depending on the broadcasting message (e.g., showing the vehicle name, MAC address, or pairing instructions, etc.). The specific wireless device may transmit the registration request message to the vehicle control apparatus, depending on a user request of the wireless device (e.g., selecting the vehicle name from a Bluetooth device list or confirming a pairing prompt, etc.). The registration request message may be referred to as a pairing request message.

The vehicle control apparatus may perform an authentication procedure in the process of pairing with the wireless device. The vehicle control apparatus may perform an authentication procedure based on a pin code, while operating in the pairing mode (e.g., to prevent unauthorized access or spoofed pairing attempts, etc.).

For example, the vehicle control apparatus may display the pin code on the display. Pin codes between the vehicle control apparatus and the wireless device should be identical to each other. The wireless device may obtain the pin code and may transmit an authentication message including the pin code to the vehicle control apparatus. Thus, authentication between the vehicle control apparatus and the wireless device may be completed (e.g., using Bluetooth Secure Simple Pairing or legacy PIN modes, etc.).

The pairing based on the pin code is exemplified in the example, but the pairing procedure is not limited thereto. Various types of pairing schemes, such as pairing based on a pass key or short range communication, or numeric comparison modes, etc., other than the above-described scheme may be applied.

In S340, the vehicle control apparatus may obtain physical information of the specific wireless device. The physical information of the specific wireless device may be Bluetooth address information of the specific wireless device (e.g., a MAC address such as 00:11:22:33:44:55, etc.).

In S350, the vehicle control apparatus may obtain a link key for the specific wireless device. For example, the vehicle control apparatus may generate the link key based on the physical information. The vehicle control apparatus may store the generated link key by interlocking the generated link key with the physical information (e.g., mapping the key to a device address and profile ID in a pairing table, etc.).

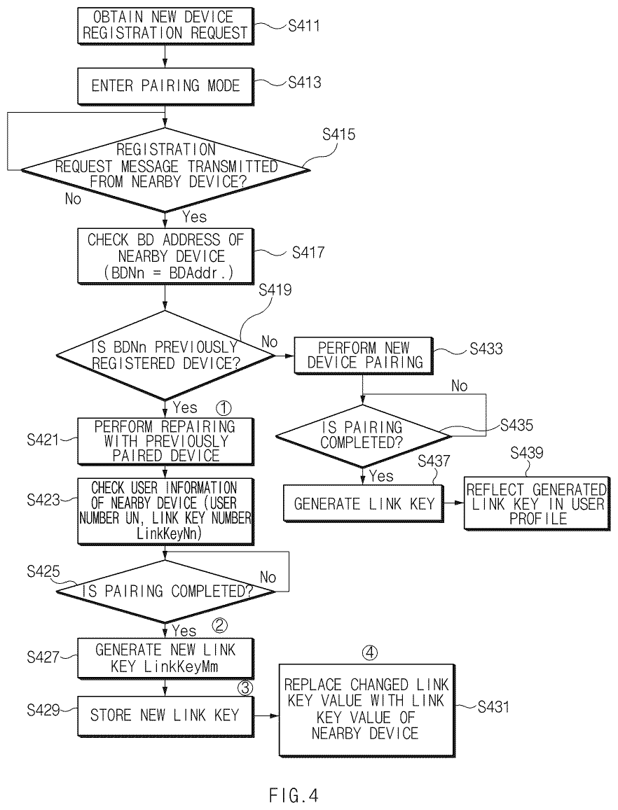

FIG. 4 shows an example of a method for registering and pairing a user profile in a vehicle control apparatus for a wireless device link according to an example of the present disclosure.

Hereinafter, it is assumed that a vehicle control apparatus 100 of FIG. 1 performs a process of FIG. 4. Furthermore, in a description of FIG. 4, it may be understood that an operation described as being performed by a vehicle control apparatus is controlled by a processor 20 of the vehicle control apparatus 100 (e.g., pairing logic, user profile resolution, or key management, etc.).

Referring to FIG. 4, if there is a registration request from a user device, a vehicle control apparatus (e.g., the vehicle control apparatus 100 of FIG. 1) may check whether the user device is a previously registered device using a physical address of the user device and may perform new pairing or re-pairing depending on the checked result (e.g., to avoid unnecessary reconfiguration or loss of prior profile settings, etc.).

In S411, the vehicle control apparatus may obtain a new device registration request. The vehicle control apparatus may obtain a new device registration request for a specific user profile, depending on an input of a user (or a passenger) or an interaction with the user (e.g., selecting a profile, tapping a connection prompt, or confirming an access permission, etc.).

In S413, the vehicle control apparatus may enter a pairing mode. The vehicle control apparatus may broadcast a pairing request message (e.g., including the vehicle name, Bluetooth MAC address, and pairing capabilities, etc.).

In S415, the vehicle control apparatus may monitor a registration request message transmitted from a nearby device (e.g., a wireless device such as iPhone). If obtaining the registration request message transmitted from the wireless device, in S417, the vehicle control apparatus may check a physical address of the wireless device. If there is no registration request from the wireless device, the vehicle control apparatus may repeatedly perform S415 (e.g., until a timeout threshold is reached or user cancels the request, etc.).

In S417, the vehicle control apparatus may obtain the physical information of the wireless device, which is included in the registration request message transmitted from the wireless device. The vehicle control apparatus may obtain the physical information of the wireless device and may check the physical information. The physical information may be a Bluetooth address (or a BD address) of the wireless device (e.g., 12:34:56:78:9A:BC, etc.). In FIGS. 4 to 6, the BD address is displayed as BDNn or BDAddNn. Herein, N is a user profile number and n is a wireless device's number in the user profile. In other words, BD11 or BDAdress11 indicates a first wireless device stored in a first user profile.

In S419, the vehicle control apparatus may check whether the wireless device is a previously registered device. The vehicle control apparatus may determine whether the obtained physical information is previously registered information. In S417, the vehicle control apparatus may check whether the obtained physical address BDNn is already registered, using the physical address BDNn. The vehicle control apparatus may determine that the wireless device corresponding to the physical address is previously registered, if the physical address is the previously registered address, and may determine that the wireless device corresponding to the physical address is not previously registered, if the physical address is not the previously registered address (e.g., by looking up an internal device table indexed by MAC address, etc.).

If the physical address is the previously registered address, the vehicle control apparatus may perform S421. If the physical address is not the previously registered address, the vehicle control apparatus may perform S433.

If the wireless device corresponding to the obtained BDNn is the previously registered device, in S421, the vehicle control apparatus may perform re-pairing with the previously paired device. The vehicle control apparatus may perform re-pairing between the wireless device and the vehicle control apparatus (e.g., to synchronize link key values across different profiles, etc.).

The vehicle control apparatus may display a pop-up menu (e.g., a password input menu) for checking a pin code or a pass key on the display, in response to the registration request message, in the re-pairing process (e.g., using a standard Bluetooth pairing dialog with numeric comparison or PIN entry, etc.).

After the registration request message is transmitted, a message for inputting a pin code or a pass key may be displayed on a user device. The user may approve pairing with the vehicle control apparatus via inputting the pin code, the pass key, or the like. An authentication message may be transmitted from the wireless device to the vehicle control apparatus, depending on the approval operation of the user. If the pairing between the vehicle control apparatus and the wireless device is completed, the vehicle control apparatus and the wireless device may mutually share the link key and may establish a communication link. The re-pairing operation between the vehicle control apparatus and the wireless device may be performed in various schemes other than the above-mentioned scheme (e.g., just works pairing, secure simple pairing, or near-field-based key exchange, etc.).

In S423, the vehicle control apparatus may check user information of the wireless device. The vehicle control apparatus may check the user information of the wireless device, while performing the re-pairing. The vehicle control apparatus may check the user information of the wireless device based on the obtained Bluetooth information. The user information may be, for example, a user number UN or a link key number LinkKeyNn (e.g., indicating the device's association with a specific profile or previous pairing context, etc.).

In S425, the vehicle control apparatus may check whether the pairing with the wireless device is completed. If the pairing is completed via exchanging of the pin code or the pass key, in S427, the vehicle control apparatus may generate a new link key LinkKeyMm for the wireless device. In S429, the vehicle control apparatus may store the new link key for the wireless device. In S431, the vehicle control apparatus may change a link key of the previously registered wireless device. The vehicle control apparatus may change link keys of all registered nearby devices to the new link key value (or the changed link key value). In S431, the vehicle control apparatus may replace the changed link key value with the link key value of the wireless device. The vehicle control apparatus may newly attempt pairing between the vehicle control apparatus and the re-paired wireless device to generate a new link key value, may delete a link key value which is previously generated between the vehicle control apparatus and the wireless device, and may store the newly generated link key value in the link key (e.g., updating all user profiles that reference the same MAC address, etc.).

In S419 to S431, the vehicle control apparatus may re-pair the wireless device, without deleting or releasing the link to the wireless device and may generate a new link key for and a new user profile and the wireless device, if the pairing is completed. Thus, a user of the nearby device may perform a desired task via the wireless device and the vehicle control apparatus, while linked to the new user profile, even without newly performing an operation of deleting or unlinking the profile (e.g., such as playing media, accessing contacts, or resuming calls, etc.).

If the wireless device is not the registered device in S419, in S433, the vehicle control apparatus may perform new device pairing. Because the wireless device is not the previously registered device, the vehicle control apparatus may perform pairing with the wireless device depending on a usual pairing procedure (e.g., creating a new profile entry, generating a new link key, and assigning a new index in memory, etc.).

The vehicle control apparatus may display a pop-up menu (e.g., a password input menu) for checking a pin code or a pass key on the display, in response to the registration request message, in the re-pairing process.

After the registration request message is transmitted, a message for inputting a pin code or a pass key may be displayed on a user device (e.g., a smartphone, smartwatch, or tablet, etc.). The user may approve pairing with the vehicle control apparatus by inputting the pin code, the pass key, or the like e.g., a numeric code, alphanumeric password, or biometric confirmation, etc.). An authentication message may be transmitted from the wireless device to the vehicle control apparatus, depending on the approval operation of the user. If the pairing between the vehicle control apparatus and the nearby device is completed, the vehicle control apparatus and the wireless device may mutually share the link key and may establish a communication link (e.g., for hands-free calling, media playback, or contact syncing, etc.). Various schemes other than the above-mentioned scheme may be applied to the re-pairing operation between the vehicle control apparatus and the wireless device (e.g., near-field communication, secure simple pairing, or just works pairing, etc.).

Depending on S433, in S435, the vehicle control apparatus may check whether the pairing is completed. If the pairing is completed, in S437, the wireless device may generate a link key for the wireless device. In S439, the vehicle control apparatus may reflect the generated link key in the user profile (e.g., by storing the key and MAC address as a new profile entry with metadata for future reconnections, etc.).

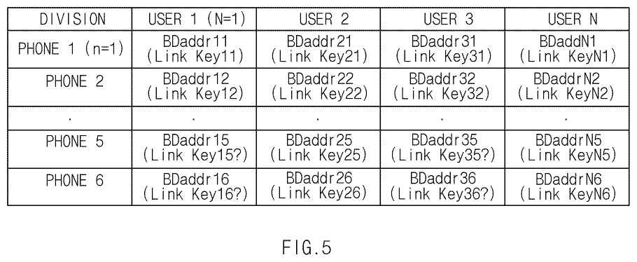

FIG. 5 shows exemplary user profile management data according to an example of the present disclosure. FIG. 5 shows exemplary user profile management data stored in a memory, according to examples of the present disclosure.

A memory (e.g., a memory 10 of FIG. 1) may store link key (LinkKey) information generated via a link between a vehicle control apparatus and nearby wireless devices DEV1 and DEV2. A user number N (or a user profile number) may be information for distinguishing a user profile. The user number N is distinct from a nearby wireless device's number n for distinguishing a nearby wireless device in a user profile (e.g., DEV1 as device 1 in user 1 profile, DEV2 as device 2 in user 2 profile, etc.).

The link key LinkKeyNn may be stored in the memory in the form of being shown in FIG. 5. The link key may be information of a nearby wireless device registered in a specific user profile (or account). A predetermined number of link keys may be assigned to the link key for each user profile (user 1, user 2, user 3, user 4, or the like).

For example, up to 6 link keys may be assigned to one profile according to a user profile operation policy. Different values may be assigned to the link key for each user profile and each nearby wireless device. Although the same nearby wireless device may be associated with different user profiles, different link key values may be assigned. On the other hand, if there are different nearby wireless devices in the same user profile, different link key values may be assigned. In FIG. 5, a link key registered for the nth time in user profile N may be represented as LinkKeyNn. A link key of the nearby device registered first in user profile 1 may be represented as LinkKey11 and a link key of the nearby wireless device registered second in user profile 1 may be represented as LinkKey12. A link key of the nearby device registered first in user profile 2 may be represented as LinkKey21 and a link key of the nearby wireless device registered second in user profile 2 may be represented as LinkKey22 (e.g., LinkKey11 for DEV1 in user 1, LinkKey22 for DEV2 in user 2, etc.).

A physical address of the nearby wireless device may be stored together with link key (LinkKey) information generated via pairing between the vehicle control apparatus and the nearby wireless devices DEV1 and DEV2 in the memory (e.g., the memory 10 of FIG. 1) (refer to FIG. 5). BDAddrNn may indicate a physical address of an nth nearby wireless device registered in user profile N. A physical address of the nearby device registered first in user profile 1 may be represented as BDaddr11 and a physical address of the nearby wireless device registered second in user profile 1 may be represented as BDaddr12. A physical address of the nearby wireless device registered first in user profile 2 may be represented as BDaddr21 and a physical address of the nearby wireless device registered second in user profile 2 may be represented as BDaddr22 (e.g., unique Bluetooth MAC addresses such as 12:34:56:78:9A:BC, etc.).

Although the nearby device is registered in another user profile according to user profile switching, a physical address of the nearby wireless device may be maintained. On the other hand, if the nearby wireless device changes to another user profile depending on the user profile, the link key may have a value different from an existing link key. The nearby wireless devices may have different pieces of physical information. The physical information of the nearby wireless device may be stored by interworking with the link key and the user profile (e.g., stored as a key-value pair {MAC address: link key} under each profile, etc.).

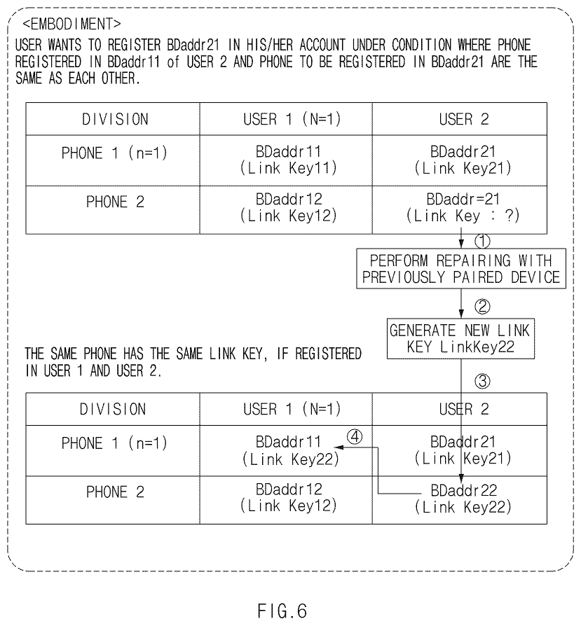

FIG. 6 shows exemplary user profile switching according to an example of the present disclosure. Hereinafter, a description will be given of storing profile data in a relationship with FIG. 4.

In FIG. 6, assuming that a device registered in BDaddr11 of a second user profile (USER 2) and a device to be registered in BDaddr21 are the same as each other, a description will be given of a process in which a user of the nearby wireless device registers BDaddr22 in his or her account (e.g., when one smartphone is used by multiple family members across different driver profiles, etc.).

A vehicle control apparatus may obtain BDaddr21. In step \textcircled{1} (S421 of FIG. 4), the vehicle control apparatus may determine whether the nearby wireless device is a device in which BDaddr21 to be registered by the user is previously registered. Because it is assumed above that BDaddr21 is the same as BDaddr11, the vehicle control apparatus may determine that BDaddr21 is previously registered (e.g., when the same smartphone was paired earlier under a different user profile, etc.). Thus, the vehicle control apparatus may generate a new link key LinkKey22 in step \textcircled{2} (S427 of FIG. 4) to register the nearby wireless device in user profile 2 without requiring manual unpairing. The vehicle control apparatus may store the generated new link key in its memory (e.g., a flash memory or EEPROM, etc.).

The vehicle control apparatus may store the new link key and Bdaddr22 in user profile 2 in step \textcircled{3} (S429 of FIG. 4) and may replace the existing link key (LinkKey11 or LinkKey12) value previously stored for the nearby device with the generated new link key (LinkKey22) value in step \textcircled{4} (S431 of FIG. 4). Thus, the link key stored for the nearby wireless device in user profile 1 may have the same value as a link key stored for the nearby wireless device in user profile 2 (e.g., allowing the same phone to operate under both driver and passenger profiles, etc.). Furthermore, a physical address BDaddr11 (or BDaddr12) of the nearby wireless device in user profile 1 may be the same as a physical address BDaddr22 of the nearby device in user profile 2. The link key may be an encrypted code generated based on pairing parameters with the paired current device (e.g., using Bluetooth Secure Simple Pairing algorithms, Diffie-Hellman key exchange, or legacy PIN-based pairing, etc.).

If there are two or more passengers, it may be assumed that the two passengers are referred to as passenger 1 and passenger 2 and passenger 1 and passenger 2 register their nearby wireless devices in a driver profile (or user profile 1), register the counterpart's nearby wireless devices in a passenger profile (or user profile 2), and use a service such as Bluetooth audio (e.g., for individual music playback, hands-free calls, or app-based controls, etc.). In this case, the nearby wireless device may recognize the vehicle (or the vehicle control apparatus) as one external device and may perform Bluetooth communication using an encryption key (or a link key or link information) with the vehicle.

If the nearby wireless device wants to register the nearby wireless device of passenger 1 already registered in the driver profile in the passenger profile, because it already generates and has the link key with the vehicle, it is unable to perform new pairing (e.g., the device treats the vehicle as already paired and refuses a second pairing without key regeneration, etc.).

As described above, the vehicle control apparatus may generate a new link key using the physical information of the nearby wireless device and may apply the generated link key to all user profiles in which the nearby wireless device is registered, thus solving an existing problem which occurs in the nearby wireless device and the vehicle control apparatus. Thus, if registering the nearby wireless device in any profile once, the user may be linked to the new user profile, even without passing through the process of deleting a device or link key from the user profile whenever changing the user profile, depending on the above-mentioned link key sharing scheme (e.g., enabling seamless switching between users in multi-driver households, etc.).

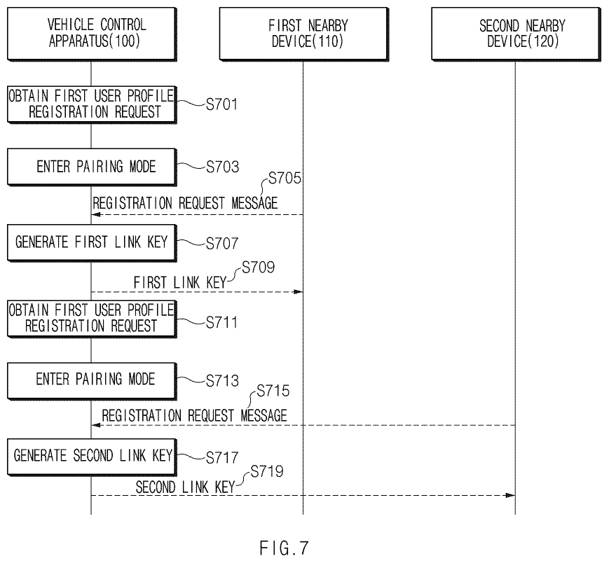

FIG. 7 is a flow diagram of a procedure for registering a user profile in a vehicle control system according to an example of the present disclosure.

Hereinafter, it is assumed that a vehicle control apparatus 100 of FIG. 1 performs a process of FIG. 7. Furthermore, in a description of FIG. 7, it may be understood that an operation described as being performed by the vehicle control apparatus 100 is controlled by a processor 20 of the vehicle control apparatus 100 for a wireless device link (e.g., Bluetooth, Wi-Fi, or Zigbee, etc.).

Referring to FIG. 7, a description will be given of the case in which a first nearby device 110 is newly registered in a vehicle control apparatus 100 and the case in which a second nearby device 120 is newly registered in the vehicle control apparatus 100 (e.g., driver's smartphone, passenger's tablet, or wearable device, etc.).

In S701, the vehicle control apparatus may obtain a first user profile registration request. Herein, it may be assumed that the first nearby device 110 is not registered in any profile of the vehicle control apparatus 100. As an example, a passenger of a vehicle may provide a selection input (e.g., a touch, voice, or gesture-based, etc.) for registering a first user profile via a display of the vehicle control apparatus 100 (e.g., a touchscreen, a heads-up display, or an infotainment screen, etc.). The vehicle control apparatus 100 may obtain the first user profile registration request based on the selection input.

In S703, the vehicle control apparatus 100 may enter a pairing mode in response to the first user profile registration request. While operating in the pairing mode, the vehicle control apparatus 100 may broadcast a broadcasting message (e.g., a pairing message) including a physical address of the vehicle (or the vehicle control apparatus 100).

In S705, the vehicle control apparatus 100 may obtain a registration request message including a first physical address, which is a physical address of the first nearby device 110, from the first nearby device 110. Herein, the first nearby device 110 may be a nearby device such as a smartphone, smartwatch, or earbud in which a user wants to perform a communication link with the vehicle.

The vehicle control apparatus 100 may determine whether the first physical address is a previously stored physical address for any user profile (e.g., stored in a memory table, a profile registry, or a Bluetooth device list, etc.). As described above, because the first nearby device 110 is the device which has never been registered, in S707, the vehicle control apparatus 100 may generate a first link key for the first nearby device 110 (e.g., using a Bluetooth pairing algorithm, a secure authentication protocol, or a shared encryption scheme, etc.). The vehicle control apparatus 100 may store a first value as the first link key. Furthermore, if the pairing is completed, the vehicle control apparatus 100 may generate the first link key in an internal memory such as EEPROM, flash memory, or RAM, etc. The vehicle control apparatus 100 may match the first value with the first user profile to store the first value (e.g., by indexing the key under a profile ID, associating with a user account name, or linking to a device slot, etc.). The physical address of the first nearby device 110 may be matched with the first user profile to be stored together with the first value (e.g., in a lookup table, a device-to-profile map, or a user-specific configuration record, etc.). The first value and the first physical address may be stored or reflected in, for example, BDaddr11 and LinkKey11 of FIG. 5 (e.g., BDaddr=MAC address, LinkKey=128-bit encryption key, etc.).

In S709, the vehicle control apparatus 100 may transmit the generated first link key to the first nearby device 110. Thus, the vehicle control apparatus 100 and the first nearby device 110 may share the first link key with each other for encrypted communication.

Hereinafter, a description will be given of a process in which the second nearby device 120 attempts to be registered in the first user profile, after the first nearby device 110 is registered.

In the state in which the first nearby device 110 is already registered in the first user profile, in S711, the vehicle control apparatus 100 may obtain the first user profile registration request (e.g., through a touchscreen selection, a voice command, a connected smartphone input, or a remote key fob interaction, etc.). Herein, it may be assumed that the second nearby device 120 is also not registered in any profile of the vehicle control apparatus 100 (e.g., a new passenger's device).

In S713, the vehicle control apparatus 100 may enter the pairing mode in response to the first user profile registration request (e.g., by activating Bluetooth discoverability, displaying a pairing prompt on a screen, enabling NFC detection, or initiating Wi-Fi Direct broadcast, etc.). While operating in the pairing mode, the vehicle control apparatus 100 may broadcast a broadcasting message (e.g., a pairing message) including a physical address of the vehicle (or the vehicle control apparatus 100). The physical address may be the same as the physical address of the vehicle, which is transmitted in S703 (e.g., a Bluetooth MAC address, Wi-Fi MAC address, vehicle-specific identifier, or other unique hardware-based address, etc.).

In S715, the vehicle control apparatus 100 may obtain a registration request message including a second physical address, which is a physical address of the second nearby device 120, from the second nearby device 120 (e.g., a smartphone, tablet, smartwatch, or wireless headset, etc.). Herein, the second nearby device 120 may be a nearby device (e.g., guest's smartphone or a temporary Bluetooth accessory) in which the user wants to perform a communication link with the vehicle.

The vehicle control apparatus 100 may determine whether the second physical address is a previously stored physical address for any user profile. As described above, because the second nearby device 120 is the device which has never been registered, in S717, the vehicle control apparatus 100 may generate a second link key for the second nearby device 120 (e.g., using a Bluetooth secure simple pairing algorithm, a passkey entry method, an out-of-band method, or a numeric comparison method, etc.). The vehicle control apparatus 100 may store a second value as the second link key (e.g., a 128-bit encryption key, a session authentication code, or a shared secret generated during the pairing process, etc.). Furthermore, if the pairing is completed, the vehicle control apparatus 100 may generate the second link key. The pairing completion may involve mutual authentication between the vehicle control apparatus 100 and the second nearby device 120. The vehicle control apparatus 100 may store the second value as the second link key (e.g., a Bluetooth Secure Simple Pairing key, a random number generated during handshake, or a cryptographic token, etc.). The vehicle control apparatus 100 may match the second value with the first user profile to store the second value. The physical address of the second nearby device 120 may be matched with the first user profile to be stored together with the second value (e.g., as a key-value pair such as {BDaddr12, LinkKey12} in a user-specific registry, etc.). The second value and the second physical address may be stored or reflected in, for example, BDaddr12 and LinkKey12 of FIG. 5 (e.g., second passenger's MAC and key pair).

In S719, the vehicle control apparatus 100 may transmit the generated second link key to the second nearby device 120. Thus, the vehicle control apparatus 100 and the second nearby device 120 may share the second link key with each other for secure connectivity.

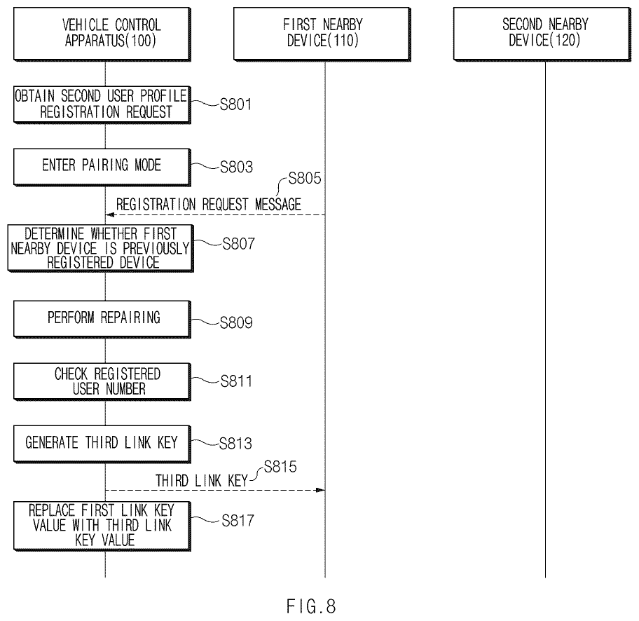

FIG. 8 is a flow diagram of a procedure for registering a user profile in a vehicle control system according to an example of the present disclosure.

Hereinafter, it is assumed that a vehicle control apparatus 100 of FIG. 1 performs a process of FIG. 8. Furthermore, in a description of FIG. 8, it may be understood that an operation described as being performed by the vehicle control apparatus 100 is controlled by a processor 20 of the vehicle control apparatus 100.

Referring to FIG. 8, a description will be given of the case in which a first nearby device 110 is first registered in the vehicle control apparatus 100 in FIG. 7 and attempts to be registered in a second user profile. If the first nearby device 110 is registered in a user profile of the vehicle control apparatus 100 for the first time, the vehicle control apparatus 100 only generates a first link key (e.g., a unique encryption key, a shared authentication token, or a device-specific identifier for secure communication, etc.). However, if the first nearby device 110 is registered in another user profile in the state in which it is already registered in the user profile once, the vehicle control apparatus 100 may generate a second link key and may change the first link key previously stored for the first nearby device 110 (e.g., to ensure consistent encryption across profiles).

In S801, the vehicle control apparatus 100 may obtain a second user profile registration request. Herein, it may be assumed that the first nearby device 110 is registered in a first user profile of the vehicle control apparatus 100. A passenger of a vehicle may provide a selection input (e.g., touch input, voice command, or button press, etc.) for registering a second user profile via a display of the vehicle control apparatus 100. The vehicle control apparatus 100 may obtain the second user profile registration request based on the selection input.

In S803, the vehicle control apparatus 100 may enter a pairing mode in response to the second user profile registration request (e.g., input via touchscreen, voice command, or mobile app, etc.). While operating in the pairing mode, the vehicle control apparatus 100 may broadcast a message (e.g., Bluetooth advertisement, discovery signal, or beacon frame, etc.) including a physical address of the vehicle (or the vehicle control apparatus 100).

In S805, the vehicle control apparatus 100 may obtain a registration request message including a physical address of the first nearby device 110 from the first nearby device 110 (e.g., through a secure handshake).

In S807, the vehicle control apparatus 100 may determine whether the first nearby device 110 is a previously registered device for any user profile (e.g., by referencing stored Bluetooth addresses, cached profile entries, or device authentication logs, etc.). The vehicle control apparatus 100 may determine whether the first physical address of the first nearby device 110 is stored in previously stored user profile data (e.g., a lookup table, device registry, or secure memory, etc.). Because the first physical address of the first nearby device 110 is stored for the first user profile (e.g., as BDaddr11 in a user profile database, pairing log, or credential map, etc.) according to the description of FIG. 7, the vehicle control apparatus 100 may determine that the first nearby device 110 is the previously registered device.

In S809, the vehicle control apparatus 100 may perform re-pairing with the first nearby device 110 (e.g., using stored credentials or keys). According to an example, the vehicle control apparatus 100 may perform mutual authentication with the first nearby device 110 in the re-pairing process (e.g., by exchanging encryption keys, validating digital certificates, or confirming PIN codes, etc.).

While the re-pairing is performed, in S811, the vehicle control apparatus 100 may check a registered user number (e.g., a profile index, account ID, or user identifier, etc.). The vehicle control apparatus 100 may check a link key value previously registered for the first nearby device 110 (e.g., LinkKey11 stored in a user profile table, memory map, or secure token list, etc.).

If the pairing is completed according to the re-pairing operation, in S813, the vehicle control apparatus 100 may generate a third link key (e.g., a new encryption key, authentication token, or Bluetooth secure key, etc.). In this operation, a value of the third link key may be a value different from the first link key value (e.g., to maintain uniqueness per profile).

The vehicle control apparatus 100 may store a third value (e.g., a unique pairing code, secure token, or device-specific key, etc.) as the third link key. The vehicle control apparatus 100 may match the third value with the second user profile to store the third value. The first physical address of the first nearby device 110 may be matched with the second user profile to be stored together with the third link key. The third value and the corresponding physical address may be stored or reflected in, for example, a paired mapping such as BDaddr22 and LinkKey22 of FIG. 5.

In S815, the vehicle control apparatus 100 may transmit the generated third link key to the first nearby device 110. Thus, the vehicle control apparatus 100 and the first nearby device 110 may share the third link key with each other (e.g., overwriting previous session credentials).

If the new third link key is generated in a relationship between the first nearby device 110 and user profile 2, the first link key (e.g., an original encryption token, Bluetooth authentication key, or handshake credential, etc.) generated in the process of pairing between the first nearby device 110 and the vehicle is present in only user profile 1 of the vehicle and is not present in the first nearby device 110. Thereafter, if the setting of the vehicle control apparatus 100 changes from user profile 2 to user profile 1, the vehicle control apparatus 100 may reinitialize or reboot (e.g., during ignition, user login, or system reset, etc.) using user profile 1 and proceeds or attempts with an automatic link with the first nearby device 110 using the first link key (e.g., LinkKey11 or a previously stored encrypted credential, etc.) with an existing first link key value. However, because the nearby device 110 has already only the third link key value, it rejects a link attempted using the first link key with the first link key value and fails in automatic link. Thus, there is an additional measure (e.g., key synchronization, link key override, or forced re-pairing, etc.) may be taken for the first link key value. Because the vehicle is able to share only one link key with one nearby device, it may delete the previously stored first link key value and may apply the third link key value in the same manner, thus solving the above-mentioned problem (e.g., avoiding handshake mismatch).

In detail, in S817, the vehicle control apparatus 100 may replace the first link key value with the third link key value (e.g., due to pairing failure, profile switch, or user command, etc.). The vehicle control apparatus 100 may change the value such that the first link key (e.g., LinkKey11) has the third link key value (e.g., LinkKey22 or a newly generated shared key, etc.). Thus, the vehicle control apparatus 100 may store the third link key value in the first link key LinkKey11 stored in the first user profile.

As a result, the nearby device and the vehicle satisfy requirements which should share one link key. The nearby device may store link information (or the link key) with the authenticated vehicle (e.g., for trusted reconnection). The user may register the nearby device in the vehicle via the pairing process (e.g., Bluetooth pairing, NFC handshake, or QR code scanning, etc.). Both user profile 1 and user profile 2 may be authenticated and registered by the user via the pairing process (e.g., entering a passkey, confirming a prompt, or tapping a confirm button, etc.).

While the nearby device is linked to the first user profile, the vehicle control apparatus 100 may transmit or receive data with the nearby device using the first link key (e.g., for music playback, contact syncing, or navigation sharing, etc.). While the nearby device is linked to the second user profile, the vehicle control apparatus 100 may transmit or receive data with the nearby device using the third link key (e.g., for call history access, messaging, or custom app settings, etc.).

As described above, because the first link key and the third link key are identical to each other as the newly generated third value (e.g., a 128-bit encrypted Bluetooth key, a secure pairing token, or a passkey-based identifier, etc.), it may be understood that the nearby device transmits or receives data using the third value.

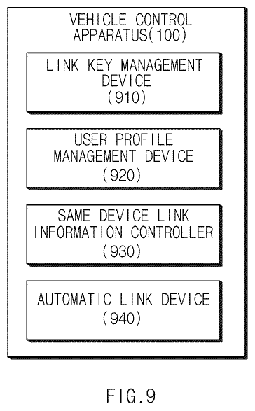

FIG. 9 shows an example of a configuration of a vehicle control apparatus for a wireless device link according to an example of the present disclosure.

Referring to FIG. 9, a vehicle control apparatus 100 according to an example may include a link key management device 910, a user profile management device 920, a same device link information controller 930, and an automatic link device 940 (e.g., implemented as a hardware processor, firmware component, software algorithm, or dedicated memory block, etc.).

The link key management device 910 may generate and store a link key which is registered in a process of pairing with a nearby device and is generated in the registration process. The link key management device 910 may generate and store the link key on the basis of a physical address (e.g., BDAddress, MAC address, or UUID, etc.) of a target nearby device. The link key management device 910 may store a link key registered in each user profile and may deliver a list of newly set nearby devices to the automatic link device 940 (e.g., when a driver switches profiles, a system update occurs, or Bluetooth settings are reset, etc.), if user information of the user profile is changed or the system is booted.

The user profile management device 920 may manage various pieces of user information of the user profile. For example, the user profile management device 920 may manage a device registration and link information (or link key) (e.g., authentication data, preferred settings, or communication history, etc.) value among the pieces of user information. However, it is not limited thereto. The user profile management device 920 may manage various pieces of user information.

The user profile management device 920 may manage, for example, generate or delete a user registration and link information database (e.g., tables storing user IDs, authentication keys, or paired device lists, etc.) by the number of user profiles permitted in the vehicle. The number of user profiles supported by one vehicle may be variously changed according to a profile operation policy. For example, the number of the user profiles supported by the one vehicle may be three (e.g., a profile for a primary driver, a spouse, or a guest, etc.). Furthermore, the number of nearby devices capable of being registered in one profile may also be determined according to the profile operation policy. For example, the number of the nearby devices capable of being registered in the one profile may be six (e.g., a smartphone, smartwatch, tablet, car key fob, Bluetooth headset, or fitness tracker, etc.).

The same device link information controller 930 may operate, if the same device is linked to different user profiles. For example, the same device link information controller 930 may perform S421 to S431 of FIG. 4 (e.g., detecting link key collisions, performing re-pairing, or synchronizing link information across profiles, etc.).

The automatic link device 940 may perform an automatic link using the previously linked nearby device (e.g., a smartphone, smartwatch, or Bluetooth-enabled car key, etc.) and the previously stored link key (e.g., a Bluetooth pairing key, secure authentication token, or encrypted identifier, etc.). If the user information of the user profile is changed or the system is booted, the automatic link device 940 may receive the list of newly set nearby devices from the link key management device 910 and may perform an automatic link with the nearby devices (e.g., to auto-unlock the doors, resume a media session, or sync driving preferences, etc.).

The automatic link device 940 may transmit a link request message to the previously registered nearby device using the link key included in the list. As a link approval message or a link response message is obtained from the nearby device, an automatic link between the existing nearby device and the vehicle may be performed (e.g., without requiring user interaction, PIN entry, or manual selection, etc.).

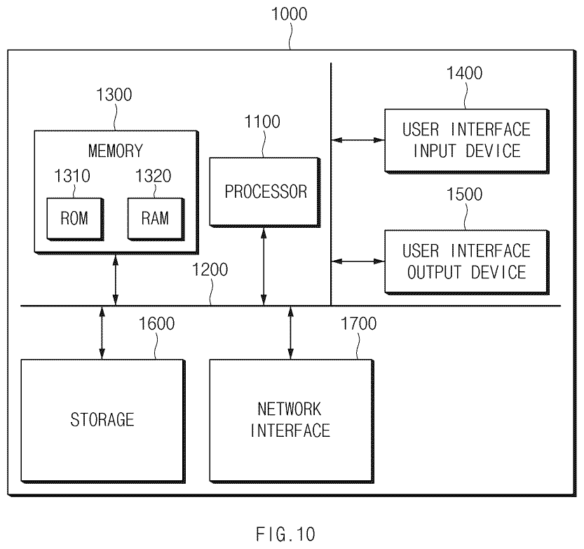

FIG. 10 shows an exemplary computing system according to an example of the present disclosure.

Referring to FIG. 10, a computing system 1000 may include at least one processor 1100, a memory 1300, a user interface input device 1400, a user interface output device 1500, a storage 1600, and a network interface 1700, which are connected with each other via a bus 1200 (e.g., a system bus, address bus, or data bus, etc.).

The processor 1100 may be a central processing unit (CPU) or a semiconductor device that processes instructions stored in the memory 1300 and/or the storage 1600. The memory 1300 and the storage 1600 may include various types of volatile or non-volatile storage media (e.g., DRAM, SRAM, NAND flash, or magnetic disk, etc.). For example, the memory 1300 may include a read only memory (ROM) 1310 and a random access memory (RAM) 1320.

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage module 1600) such as a RAM, a flash memory, a ROM, an EPROM, an EEPROM, a register, a hard disc, a removable disk, and a CD-ROM (e.g., USB drive, SD card, or cloud-backed storage, etc.).

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal (e.g., vehicle infotainment unit, smartphone, or tablet, etc.). In another case, the processor and the storage medium may reside in the user terminal as separate components.

An example of the present disclosure provides a vehicle control apparatus for matching a nearby device with a plurality of user profiles and a method thereof.

Another example of the present disclosure provides a vehicle control apparatus for a wireless device link for providing the same user with a switching function between a plurality of user profiles and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus for a wireless device link may include storage storing a user profile and a link key, a processor that obtains a second user profile registration request, in a state in which a physical address of a specific nearby device and a first link key are matched with a first user profile to be stored in the storage, operates in a pairing mode in response to the second user profile registration request, obtains a registration request message from the specific nearby device, generates a second link key with a second value for a link with the specific nearby device based on the physical address, and changes the first link key, based on the second link key, and a communication module that transmits the second link key to the specific nearby device under control of the processor.

In an example, the processor may match the second link key with a second user profile to store the second link key in the storage.

In an example, the first link key may have a first value and the second link key may have the second value.

In an example, the processor may change the first link key to the second value, after the second link key is generated.

In an example, the processor may match a second user profile with the second link key and the physical address of the specific nearby device to store the second user profile in the storage.

In an example, the physical information may be a Bluetooth address of the specific nearby device.

In an example, the registration request message may include the physical address of the specific nearby device.

In an example, the processor may determine whether the physical address included in the registration request message is an address previously stored in the storage.

In an example, the processor may check a link key stored by being matched with the physical address, depending on the determination.

In an example, the registration request message may include a pin code associated with the vehicle control apparatus.

In an example, the vehicle control apparatus may further include a display.

In an example, the processor may display a pin code on the display, while operating in the pairing mode.

In an example, the processor may transmit a broadcasting message, while operating in the pairing mode.

In an example, the broadcasting message may include a physical address of a vehicle.

In an example, the physical address of the vehicle may be a media access control (MAC) address.

In an example, the processor may obtain the second user profile registration request via the display.

In an example, the processor may transmit or receive data with the specific nearby device using the first link key, via the communication module, while the specific nearby device is linked to the first user profile.

In an example, the processor may transmit or receive data with the specific nearby device using the second link key, via the communication module, while the specific nearby device is linked to a second user profile.

In an example, a value corresponding to the first link key for the specific nearby device may be the same as a value corresponding to the second link key.

According to another example of the present disclosure, a vehicle control method may include obtaining a second user profile registration request, in a state in which a physical address of a specific nearby device and a first link key are matched with a first user profile to be stored, activating a pairing mode in response to the second user profile registration request, obtaining a registration request message from the specific nearby device, generating a second link key for a link with the specific nearby device based on the physical address, transmitting the second link key to the specific nearby device, and changing the first link key, based on the second link key.

In an example, the vehicle control method may further include matching the second link key with a second user profile to store the second link key in storage included in the vehicle control apparatus.

In an example, the first link key may have a first value and the second link key may have a second value. The first link key may change to the second value, after the second link key is generated.

In an example, the vehicle control method may further include matching a second user profile with the second link key and the physical address of the specific nearby device to store the second user profile in storage included in the vehicle control apparatus.

In an example, the physical information may be a Bluetooth address of the specific nearby device.

According to an example of the present disclosure, the device already interworking with a user profile may link a nearby device to another user profile even without performing all processes of initial user registration.

Furthermore, according to an example of the present disclosure, the vehicle control apparatus may more quickly link the nearby device and the user profile, upon a change in user profile or a registration request.

In addition, various effects ascertained directly or indirectly through the present disclosure may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

Therefore, examples of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus of a vehicle, the apparatus comprising:
a processor; and
a memory storing at least one instruction that, when executed by the processor communicating with the memory, is configured to cause the apparatus to:
store a first user profile and a first link key associated with a wireless device,
obtain a second user profile registration request, in a state in which a physical address of the wireless device and the first link key are stored in association with the first user profile in the memory,
activate, based on the second user profile registration request, a pairing mode,
obtain, from the wireless device, a registration request message,
generate, based on the physical address of the wireless device, a second link key with a second value for a link with the wireless device,
update, based on the second link key, the first link key in association with the first user profile, and
transmit, via a wireless communication interface of the vehicle, the second link key to the wireless device.

2. The apparatus of claim 1, wherein the at least one instruction, when executed by the processor communicating with the memory, is configured to cause the apparatus to:
match the second link key with the second user profile to store the second link key in the memory.

3. The apparatus of claim 1, wherein the first link key has a first value and the second link key has the second value, and
wherein the at least one instruction, when executed by the processor communicating with the memory, is configured to cause the apparatus to:
after the second link key is generated, change the first value of the first link key to the second value.

4. The apparatus of claim 1, wherein the at least one instruction, when executed by the processor communicating with the memory, is configured to cause the apparatus to:
store the second link key and the physical address of the wireless device in association with the second user profile in the memory.

5. The apparatus of claim 1, wherein the physical address comprises a Bluetooth address of the wireless device.

6. The apparatus of claim 1, wherein the registration request message comprises the physical address of the wireless device.

7. The apparatus of claim 6, wherein the at least one instruction, when executed by the processor communicating with the memory, is configured to cause the apparatus to:
determine whether the physical address included in the registration request message is an address previously stored in the memory.

8. The apparatus of claim 7, wherein the at least one instruction, when executed by the processor communicating with the memory, is configured to cause the apparatus to:
retrieve, based on a determination that the physical address is the address previously stored in the memory, a link key associated with the physical address.

9. The apparatus of claim 1, wherein the registration request message comprises a pin code associated with the apparatus.

10. The apparatus of claim 1, further comprising:
a display,
wherein the at least one instruction, when executed by the processor communicating with the memory, is configured to cause the apparatus to:
display a pin code on the display, while operating in the pairing mode.

11. The apparatus of claim 1, wherein the at least one instruction, when executed by the processor communicating with the memory, is configured to cause the apparatus to:
transmit a broadcasting message, while operating in the pairing mode.

12. The apparatus of claim 11, wherein the broadcasting message comprises a physical address of the vehicle.

13. The apparatus of claim 12, wherein the physical address of the vehicle comprises a media access control (MAC) address.

14. The apparatus of claim 1, further comprising:
a display,
wherein the at least one instruction, when executed by the processor communicating with the memory, is configured to cause the apparatus to:
obtain, via the display, the second user profile registration request.

15. The apparatus of claim 1, wherein the at least one instruction, when executed by the processor communicating with the memory, is configured to cause the apparatus to:
transmit or receive, via the wireless communication interface, data with the wireless device using the first link key, while the wireless device is linked to the first user profile; and
transmit or receive, via the wireless communication interface, data to or from the wireless device using the second link key, while the wireless device is linked to the second user profile, and
wherein a value corresponding to the first link key for the wireless device is the same as a value corresponding to the second link key while the wireless device is linked to the second user profile.

16. A method performed by an apparatus of a vehicle, the method comprising:
obtaining a second user profile registration request for registering a second user profile, in a state in which a physical address of a wireless device and a first link key are stored in association with a first user profile in a memory of the apparatus;
activating, based on the second user profile registration request, a pairing mode; obtaining a registration request message from the wireless device;
generating, based on the physical address of the wireless device, a second link key for a link with the wireless device;
transmitting, via a wireless communication interface of the vehicle, the second link key to the wireless device; and
updating, based on the second key link, the first link key in association with the first user profile.

17. The method of claim 16, further comprising:
matching the second link key with the second user profile to store the second link key in the memory of the apparatus.

18. A vehicle comprising:
a wireless communication interface;
a processor; and
a memory storing at least one instruction that, when executed by the processor communicating with the memory, is configured to cause the vehicle to:
store a plurality of user profiles, wherein each user profile comprising a set of records associated with at least one wireless device, and each record of the set of records comprises a physical address and a link key associated with the wireless device;
receive, from the wireless device, a request to register the wireless device under a second user profile, wherein the physical address of the wireless device is previously registered under a first user profile with a first link key, and wherein the first link key is stored in association with the first user profile;
perform, in response to the request, a pairing operation with the wireless device to generate a second link key associated with the physical address of the wireless device;
store the second link key in association with the second user profile;
for the record, of the first user profile, associated with the at least one wireless device, update the first link key with the second link key;
transmit, via the wireless communication interface, a signal indicating that the second link key is associated with the second user profile; and
control, based on the signal, wireless communication between the vehicle and the wireless device using the second link key.

19. The vehicle of claim 18, wherein the at least one instruction, when executed by the processor communicating with the memory, is configured to cause the vehicle to store, for each user profile of the plurality of user profiles, up to a predetermined number of records associated with a plurality of wireless devices, each record comprising a distinct physical address and a corresponding link key.

20. The vehicle of claim 18, wherein the at least one instruction, when executed by the processor communicating with the memory, is configured to cause the vehicle to, after generating the second link key:
identify user profiles that include a record associated with the same physical address of the wireless device, and
replace each corresponding link key in the identified user profiles with the second link key.
